(19) United States
(12) Patent Application Publication
(10) Pub. No.: US 2026/0073432 A1
(43) Pub. Date: Mar. 12, 2026

(54) AI-POWERED AUTOMATED RATING SYSTEM

(71) Applicant: AIR Platforms, Inc., Cross River, NY (US)

(72) Inventors: Joseph Burdis, Cross River, NY (US); Arbi Abeshi, Cross River, NY (US); Glenn Carvajal, Cross River, NY (US)

(21) Appl. No.: 19/325,831

(22) Filed: Sep. 11, 2025

Related U.S. Application Data
(60) Provisional application No. 63/693,538, filed on Sep. 11, 2024.

(51) Int. Cl. G06Q 30/0282; G06Q 40/03

(52) U.S. Cl. CPC G06Q 30/0282; G06Q 40/033

(57) ABSTRACT

An AI-powered rating system includes a central artificial intelligence (AI) agent framework configured to orchestrate a rating process and automatically utilize available tools for data gathering and extraction; a data processing pipeline configured to simultaneously handle multiple streams of information from diverse sources, including structured data and unstructured data; a machine learning infrastructure comprising multiple specialized artificial intelligence models, each configured to evaluate a specific type of entity; a generative AI integration layer configured to provide a natural language explanation of a rating result for the rating process and enable conversational interaction with the system, where the generative AI integration layer is further configured to transform the unstructured data into quantifiable risk signals that are integrated with a structured data processing stream; and an output generation and reporting engine configured to deliver the rating result through one or more channels and formats.

### CROSS-REFERENCE TO RELATED APPLICATIONS

This application claims priority to U.S. Provisional Patent Application No. 63/693,538, filed Sep. 11, 2024, entitled “AI-Powered Automated Rating System,” the entire content of which is incorporated by reference herein.

### TECHNICAL FIELD

The present disclosure generally relates to artificial intelligence (AI)-powered autonomous systems, and more specifically to an AI-powered automated system for generating asset ratings with an integrated agent-based architecture and machine learning methodologies for comprehensive credit risk assessment.

### BACKGROUND OF THE DISCLOSURE

Traditional asset rating evaluation relies on historical data and predefined rules, where the historical data used in asset rating is often limited in quality and scope, and rule-based rating decision-making lacks flexibility. The existing asset rating infrastructure suffers from significant technical constraints that prevent accurate and timely risk assessment in modern financial markets. Since traditional asset rating depends on human judgment, an objective asset rating may not be obtained due to human biases, and traditional asset rating approaches need a long processing time, preventing real-time asset rating determination. These systems typically operate on batch processing models with periodic review cycles that can span months or quarters, creating substantial delays between when risk factors emerge and when they are reflected in asset ratings. The reliance on predefined rule-based algorithms means that existing systems cannot adapt to novel risk patterns or complex interdependencies between variables that were not anticipated during the original system design. Most common approaches predict defaults directly using empirical or structural models, but such approaches usually require a large amount of data, good data understanding, and reliable data pattern recognition to obtain reasonable predictions; however, this is not guaranteed. The technical architecture of traditional systems is fundamentally constrained by their inability to process diverse data types simultaneously, leading to incomplete risk assessments that miss critical indicators of credit deterioration or improvement.

The existing asset rating infrastructure also faces severe technical limitations in data processing and integration capabilities that prevent comprehensive risk analysis. Since unstructured data is stored in its native format and is not defined, it may need to be pre-processed before further analysis, yet traditional systems lack the sophisticated natural language processing and document understanding capabilities required to extract meaningful information from unstructured sources such as earnings call transcripts, news articles, regulatory filings, and management communications. The existing asset rating systems primarily rely on structured financial data from standardized sources, creating significant blind spots in risk assessment where critical information contained in unstructured formats remains inaccessible to analytical processes. The technical challenge is compounded by the heterogeneous nature of financial data sources, which exist in disparate formats, use different reporting standards, and operate on varying update frequencies that traditional systems cannot effectively harmonize. Existing data integration architectures struggle with real-time data ingestion and processing, often requiring manual intervention to resolve data quality issues, handle missing information, or reconcile conflicting data points from different sources. The lack of automated data validation and cleansing capabilities means that traditional systems are vulnerable to errors, inconsistencies, and outdated information that can significantly compromise the accuracy of credit assessments.

Traditional asset rating systems also suffer from fundamental computational limitations that prevent them from leveraging advanced analytical techniques and processing capabilities required for modern risk assessment. The existing infrastructure typically relies on linear statistical models and simple regression techniques that cannot capture complex, non-linear relationships between risk factors or identify subtle patterns that may indicate emerging credit risks. The rating methodologies may go a step further with regards to how each of the five asset classes as designated by the securities and exchange commission (SEC) under the nationally recognized statistical rating organization (NRSRO) act are rated and monitored across five specific categories of entities or securities, yet the existing asset rating systems lack the technical sophistication to dynamically adjust their analytical approaches based on asset class characteristics or market conditions. The computational architecture of existing systems is not designed to handle the volume, velocity, and variety of data required for comprehensive modern risk assessment, leading to processing bottlenecks and analytical limitations that prevent real-time or near-real-time credit evaluation (e.g., instant credit approval or rejection). Traditional systems also lack the technical capability to perform sophisticated scenario analysis or stress testing that could provide valuable insights into how credit quality might change under different economic or market conditions. The absence of advanced machine learning capabilities means that existing systems cannot learn from new data patterns or automatically improve their predictive accuracy over time, resulting in static analytical frameworks that become increasingly obsolete as market conditions evolve. Furthermore, traditional systems lack the technical infrastructure to provide transparent, explainable results that regulatory authorities and market participants increasingly demand, creating compliance and trust issues that limit their effectiveness in modern financial markets.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY OF THE DISCLOSURE

The present disclosure addresses the above problems and other problems in the existing asset management systems by providing an artificial intelligence (AI)-powered automated system for generating asset ratings.

According to one embodiment, AI-powered rating system includes a central artificial intelligence (AI) agent framework configured to orchestrate a rating process and automatically utilize available tools for data gathering and extraction; a data processing pipeline configured to simultaneously handle multiple streams of information from diverse sources, including structured data and unstructured data; a machine learning infrastructure comprising multiple specialized artificial intelligence models, each configured to evaluate a specific type of entity; a generative AI integration layer configured to provide a natural language explanation of a rating result for the rating process and enable conversational interaction with the system, where the generative AI integration layer is further configured to transform the unstructured data into quantifiable risk signals that are integrated with a structured data processing stream; and an output generation and reporting engine configured to deliver the rating result through one or more channels and formats.

According to another embodiment, a computer-implemented method for generating AI-powered asset ratings includes receiving, by a central AI agent framework, a request for credit assessment of an entity; automatically gathering, by the central AI agent framework, data from multiple sources including structured data and unstructured data; processing the gathered data through a data processing pipeline configured to handle diverse data formats, where processing the gathered data comprises transforming the unstructured data into quantifiable risk signals that are integrated with a structured data processing stream; executing one or more specialized machine learning models on the processed data to generate a risk assessment; converting model outputs into standardized probability scores through data transformation; and generating a rating by mapping the probability scores to traditional rating categories through historical calibration.

The foregoing is a summary and thus contains, by necessity, simplifications, generalizations, and omissions of detail; consequently, the summary is illustrative only and is not limiting in any way. Other aspects, inventive features, and advantages of the systems and/or processes described herein may become apparent in the non-limiting detailed description set forth herein.

### BRIEF DESCRIPTION OF THE DRAWINGS

These and other features, aspects, and advantages of the present disclosure may become better understood with regard to the following description, and accompanying drawings, where:

Figure (FIG.) 1 is a schematic diagram illustrating an example system architecture for AI-powered asset rating, according to some embodiments.

FIG. 2 is a schematic diagram illustrating example components included in an AI-powered asset rating system, according to some embodiments.

FIG. 3 is a flow diagram illustrating an example data pipeline processing in the AI-powered asset rating system, according to some embodiments.

FIG. 4 is a flow diagram illustrating an example modeling pipeline processing in the AI-powered asset rating system, according to some embodiments.

FIG. 5 is a flow diagram illustrating an example inference/scoring process in the AI-powered asset rating system, according to some embodiment.

FIG. 6 is a flow diagram illustrating an example query handling process in the AI-powered asset rating system, according to some embodiments.

FIG. 7 is a flow diagram illustrating a combined approach in the AI-powered asset rating system, according to some embodiments.

FIG. 8 is a block diagram showing an example computing device for implementing systems and methods described in reference to FIGS. 1-7.

### DETAILED DESCRIPTION

To make the aforementioned objects, features, and advantages of the present disclosure more obvious and understandable, the present disclosure may be further described below with reference to the accompanying drawings and embodiments.

It should be noted that specific details are set forth in the following description to fully understand the present disclosure. However, the present disclosure may be implemented in many other ways different from those described herein, and those skilled in the art may make similar generalizations without violating the connotation of the present disclosure. Therefore, the present disclosure is not limited by the specific embodiments disclosed below.

The terms used in the embodiments of the present disclosure are only for the purpose of describing specific embodiments and are not intended to limit the present disclosure. The singular forms of “a”, “said” and “the” used in the embodiments of the present disclosure and the appended claims are also intended to include plural forms unless the context clearly indicates other meanings.

It should be noted that the example embodiments may be implemented in various forms, and should not be construed as being limited to the embodiments set forth herein. On the contrary, the provision of these embodiments makes the present disclosure more comprehensive and complete, and fully conveys the concept of the example embodiments to those skilled in the art. The same reference numerals in the figures indicate the same or similar structures, and thus their repeated description may be omitted. In addition, the similarities between the embodiments may not be repeated.

### Motivation and Benefits

As described earlier, traditional asset rating evaluation relies on historical data and predefined rules, where the historical data used in asset rating is often limited in quality and scope, and rule-based rating decision-making lacks flexibility. The existing systems also face critical technical challenges, including the inability to process unstructured data effectively, as unstructured data is stored in its native format and is not defined, requiring pre-processing before further analysis. Existing approaches predict defaults directly using empirical or structural models, but such approaches usually require a large amount of data, good data understanding, and reliable data pattern recognition to obtain reasonable predictions; however, this is not guaranteed. Additionally, traditional systems struggle with temporal data misalignment, where annual data needs to be converted into quarterly format because that's what the model is expecting, and lack the computational infrastructure to handle real-time processing and dynamic market adaptation.

To address the above problems and other problems in the existing asset rating systems, the present disclosure provides an autonomous AI-powered asset rating system for generating asset ratings and corresponding analysis that revolutionizes traditional asset assessment by leveraging advanced machine learning algorithms to analyze vast arrays of data points from diverse data sources beyond traditional scoring systems. The core technical solution centers around a central generative AI (GenAI) agent that can use all these tools automatically, where a user can just ask it a question and the agent knows where to grab the data and how to extract the data, operating through continuing to build more sophisticated tools or improve the tools, as well as improving the agent by leveraging those tools. The AI-powered credit rating agent sits on top of the AI and machine learning (ML) rating methodology and enables end-to-end integration of multiple components of the rating system to work seamlessly together from interpreting user inputs, extracting and spreading financials, generating and organizing research, translating research into projected financials, assigning risk scores to credit-relevant events, and running ML rating models.

A notable aspect of the technical solution is the indirect risk prediction methodology, where instead of directly predicting a probability of default, the system employs the models using collected data to predict an option-adjusted spread (OAS), and then estimate the probability of default based on the predicted OAS. This represents a unique approach to indirectly predicting the defaults from the OAS, addressing the reliability issues inherent in direct default prediction methods. The system implements a data pipeline that is used in three places: to build models, when making predictions on actual data, and for predictions that generative AI agents create for what-if scenarios and hypotheticals.

The technical architecture incorporates sophisticated data processing capabilities, where the system applies unique scripts that make use of machine learning (natural language processing) and generative AI to automatically extract and structure the information. The generative AI models may be open-source models and closed-source models. The system uses intelligent workflows to process regulatory data by performing data quality check and data cleaning including removing duplicate or irrelevant data, filtering undesired outliers, fixing errors in type conversion and syntax. The solution addresses temporal data challenges by automatically handling conversions and aggregations needed for machine learning model inputs.

The system implements advanced feature engineering and model optimization techniques, where the system determines a direction of credit impact for each feature, interactively removes level features that have minimal impact to reduce the effect of company size, clips extreme feature values to mitigate overfitting/sharp edges, and automatically detects sharp edges from features at model results using individual conditional expectation (ICE) plots. The system determines training window length and decaying weight approach to maximize performance, uses cross-validation to determine hyperparameter settings, and fits models daily to ensure continuous adaptation to changing market conditions.

When an asset, such as an entity, an issue, or a structured product, is identified to have a low rating below a pre-defined threshold, the system may further intervene at the earliest phase to avoid or mitigate any potential negative impacts in the subsequent strategy decisions. The system may send out a flagged alert through a message transmission application to one or more remote devices to act on the identified structured product, where even if a remote device was not connected to the system when the alert was first sent, the system may activate the message transmission application to cause the flagged alert to display on the remote system and to enable the connection to relevant data stored in the system when the remote device comes online.

The technical solutions offer several advantages when compared to the existing asset rating systems. First, the AI-powered asset rating system provides substantial improvements in processing speed and accuracy. The disclosed AI-powered automation pipeline explains the quantitative predictions from the models and reasoning in real-time, and provides credit-focused, distilled news summary reports in real-time, which not only reduces manual operations but also enables timely strategy decision-making (e.g., instant credit approval or rejection with an explanation). The system achieves automated data quality assurance through data quality checks and data cleaning, significantly reducing the risk of errors and inconsistencies that plague traditional systems.

The indirect OAS-based prediction approach provides enhanced reliability compared to direct default prediction methods, addressing the fundamental technical limitations where direct approaches are not guaranteed to provide reasonable predictions. The extensive data collection allows for a more holistic view of behavior and activity data and provides a richer insight when rating the entity, issue, and/or the structured product, enabling more comprehensive and accurate risk assessments.

The agent-based architecture delivers significant operational benefits by automatically going from unstructured to ratings in kind of one go, eliminating manual processing steps. The system automatically gets extracted and structured data and essentially gets ready to run through the machine learning model, and can reference that in scenario analysis for adjacent non-financial information. This end-to-end automation provides technical improvement by providing early intervention capabilities by identifying an entity, issue, or structured product having a low rating below a pre-defined threshold and can intervene at the earliest phase to avoid or mitigate any potential negative impacts in the subsequent strategy decisions.

The integration of generative AI with machine learning models creates synergistic benefits where the sum of the parts is so much bigger than the individual pieces, creating a comprehensive system where the whole provides greater value than individual components. The technical benefit includes that interplay between generative AI, and then directly using the machine learning model, and explaining the machine learning model, not just in a static way, but in a kind of what-if, scenario-based, or simulation-based approach. The system provides automated traceability and transparency through automated documentation of where every line item, like how this number was calculated, like where it came from, preventing AI hallucinations, addressing critical concerns about AI reliability in various applications.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

### Overall System Architecture

In the following, the autonomous AI-powered asset rating system is described with reference to assets (such as a company (public or private), a government (local or national), etc.), issues, or synthetic products for default or fail prediction (e.g., fail to make repayment of a debt by an entity). However, it is to be noted that the disclosed autonomous AI-powered asset rating system is not limited to such applications, but can be applied to many other applications, such as distress, forced restructuring, or signs of high credit quality, etc., and may be applied to different fields, such as cybersecurity risk assessment, automated diagnostic assistance and treatment pathway recommendations, emergency response resource allocation, and early warning systems for natural disasters or public health crises, etc. For example, the AI-powered asset rating system may analyze network traffic, security logs, threat intelligence feeds, and organizational data to provide continuous cybersecurity risk scoring and threat prediction for enterprise security management (e.g., enable early intervention in case of a predicted risk).

FIG. 1 is a schematic diagram illustrating an example system architecture 100 for AI-powered asset rating, according to some embodiments. As illustrated in FIG. 1, the system architecture 100 may include a AI-powered asset rating system 110 operatively coupled, via a network 120, to one or more user devices 130a, . . . , 103n (e.g., a mobile phone, computer, laptop, tablet, terminal, automated teller machine, wearable device, and the like), one or more third-party systems 140, and a real-time monitoring and alert system 150. The network 120 may interconnect the AI-powered asset rating system 110, user devices 130, real-time monitoring and alert system 150 with third-party system(s) 140. In this way, the AI-powered asset rating system 110 may send information to and receive information from the user devices 130, the third-party system(s) 140 and the real-time monitoring and alert system 150.

In the illustrated embodiment, a plurality of user devices 130 provide a plurality of communication channels through which the AI-powered asset rating system 110, third-party system(s) 140, and/or real-time monitoring and alert system 150 may communicate with the user device 130 over the network 120.

In the illustrated embodiment in FIG. 1, the AI-powered asset rating system 110 may be configured to generate asset ratings and corresponding analysis that revolutionize traditional asset assessment by leveraging advanced machine learning algorithms to analyze vast arrays of data points from diverse data sources beyond traditional scoring systems. This approach may result in more dynamic, comprehensive, and accurate evaluation of entity assets such as creditworthiness compared to conventional methodologies. In some embodiments, the AI-powered asset rating system 110 may further include one or more generative artificial intelligence (AI) or other machine learning models 160 for generating asset ratings and corresponding analysis and for other different purposes as described elsewhere in the disclosure. For example, the AI-powered asset rating system 110 may apply unique scripts that make use of machine learning such as natural language processing (NLP) and generative AI to automatically extract and structure collected information for asset rating and analysis, where the generative AI models may be open-source models and closed-source models.

The network 120 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or a combination of wireless interfaces. As an example, a network in one or more networks 120 may include a short-range communication channel, such as Bluetooth or a Bluetooth low energy channel. A wired network may include a wired interface. The wired and/or wireless networks may be implemented using routers, access points, bridges, gateways, or the like, to connect devices in the system. The one or more networks 120 may be incorporated entirely within or may include an intranet, an extranet, or a combination thereof. In one embodiment, communications between two or more systems and/or devices may be achieved by a secure communications protocol, such as a secure sockets layer or transport layer security. In addition, data and/or personal user information may be encrypted before transmission.

The user device 103 may be any computing endpoint capable of network communication with the orchestration environment. In some embodiments, the user device 130 may be a desktop computer, laptop, tablet, or mobile device. The device may run a graphical user interface (GUI) or web-based client application that allows a user 135 (e.g., an expert) to enter user queries, upload structured and unstructured data, or annotate business-specific constraints. For example, the user device 130 may enable users to converse with the generative AI and further query on credit-related matters.

The user 135 refers to the human actor, such as a subject matter expert (SME), business analyst, or data scientist, who may interact with the AI-powered asset rating system 110 through the user device 130 and serves as the source of domain knowledge and governance. For example, the user 135 may provide important inputs that anchor the AI-powered asset rating pipeline to real-world requirements. At the outset, the user 135 may dump a zip file containing financials and other documents, which automatically gets extracted, structured, and prepared to run through machine learning models and diagrams. The process may automatically go from unstructured data to ratings in one step. For another example, the user 135 may input a user query about entity, issue, or portfolio of companies/issuance, and then consume content (ratings, reasoning explanation, etc.) generated by the system in different manners including user interfaces (UIs), application programming interfaces (APIs), data feeds, email notifications, and/or text notifications. The user may also consume the content through a specific application installed on a user device 130 associated with the user, such as a Microsoft® application (e.g., Word, Excel, PowerPoint), a Google® application (e.g., Sheets, Slides, plugins), etc. In some embodiments, the disclosed framework may be integrated into other different platforms to make ratings/data available through these platforms. Such exemplary platforms may include but are not limited to Bloomberg®, Factset®, Refinitiv®, etc.

The third-party system(s) 140 refer to the external software services, data sources, or processing platforms that the AI-powered asset rating system 110 may interface with during various stages of operation. They are not part of the core multi-agent system but provide auxiliary inputs, enrichment, or integration points that improve asset rating. From a technical perspective, the third-party system(s) 140 may take several forms. One class of systems includes external data providers or knowledge bases, such as Bloomberg® terminal/API that provides real-time market data, financial statements, corporate actions, and news feeds, satellite imagery providers (e.g., Planet Labs®, Maxar®) that offer economic activity monitoring through satellite data, web scraping services (e.g., Diffbot®, Import.io®) for automated collection of public web data, regulatory databases such as electronic data gathering, analysis, and retrieval (EDGAR) for corporate filings and regulatory submissions, etc. Another class may include risk management and analytics platforms, such as Moody's® Analytics for credit risk models and portfolio analytics, IBM® OpenPages for governance, risk, and compliance management, BlackRock® Aladdin for investment management and risk analytics, etc. Other third-party systems may include but are not limited to technical infrastructure systems (e.g., Amazon® AWS, Microsoft® Azure, Google® Cloud, etc.), commination and notification systems (e.g., SendGrid®, PagerDuty®, Twilio®, D3.js® frameworks, etc.), trading and execution systems, etc. In some embodiments, generative AI or other machine learning models 160 in the AI-powered asset rating system 110 may be a part of the third-party systems 140 instead.

The real-time monitoring and alert system 150 refers to the downstream implementation that consumes ratings generated by the AI-powered asset rating system 110. The system disclosed herein may enable real-time or near-real-time credit evaluation (e.g., instant credit approval or rejection), where the existing approaches generally rely on human evaluation for certain applicants due to the mixed information from different sources, especially when the mixed information includes portions obtained from the unstructured data, such as reviews from certain online sources. The system disclosed herein may further provide early intervention capabilities by identifying an entity, issue, or structured product having a low rating below a pre-defined threshold and can intervene at the earliest phase to avoid or mitigate any potential negative impacts in the subsequent strategy decisions. A structured product may include, but is not limited to, residential mortgage-backed securities (RMBS), asset-backed securities (ABS), commercial mortgage-backed securities (CMBS), collateralized debt obligations (CDO), collateralized loan obligations (CLOs), etc.

The AI-powered asset rating system 110 may continuously process incoming data streams from multiple sources including market data feeds, regulatory filings, news services, and alternative data providers to detect changes in risk factors that could impact asset ratings. The real-time monitoring and alert system 150 consistently monitors the generated ratings and may send out a flagged alert through a message transmission application to one or more remote devices to act on the identified structured product. Even if a remote device was not connected to the system when the alert was first sent, the system may activate the message transmission application to cause the flagged alert to display on the remote system and to enable the connection to relevant data stored in the system when the remote device comes online. In some embodiments, the monitoring system employs machine learning algorithms to establish dynamic thresholds based on historical patterns and market conditions, automatically adjusting sensitivity levels to reduce false positives while ensuring critical risk events are promptly identified. The alert system architecture may include multiple notification channels and escalation procedures, where alerts may be categorized by severity level and routed to appropriate stakeholders based on predefined criteria and organizational hierarchies.

The system fits models daily and thus the real-time monitoring and alert system 150 may further continuously monitor model performance metrics, automatically triggering alerts when model accuracy degrades or when significant changes in feature importance are detected, ensuring the reliability and effectiveness of the rating system disclosed herein. The alert delivery mechanism supports various communication protocols including email, SMS, mobile push notifications, and API-based integrations with third-party risk management systems, providing comprehensive coverage for different operational environments and ensuring that critical information reaches decision-makers regardless of their location or preferred communication method.

FIG. 1 illustrates only one example of an embodiment of the architecture 100. It will be appreciated that in other embodiments, one or more of the systems, devices, or applications may be combined into a single system, device, or application, or be made up of multiple systems, devices, or applications. It is further understood that one or more of the servers, systems, and applications may be combined in other embodiments and still function in the same or similar way as the embodiments described herein.

### AI-powered Asset Rating System

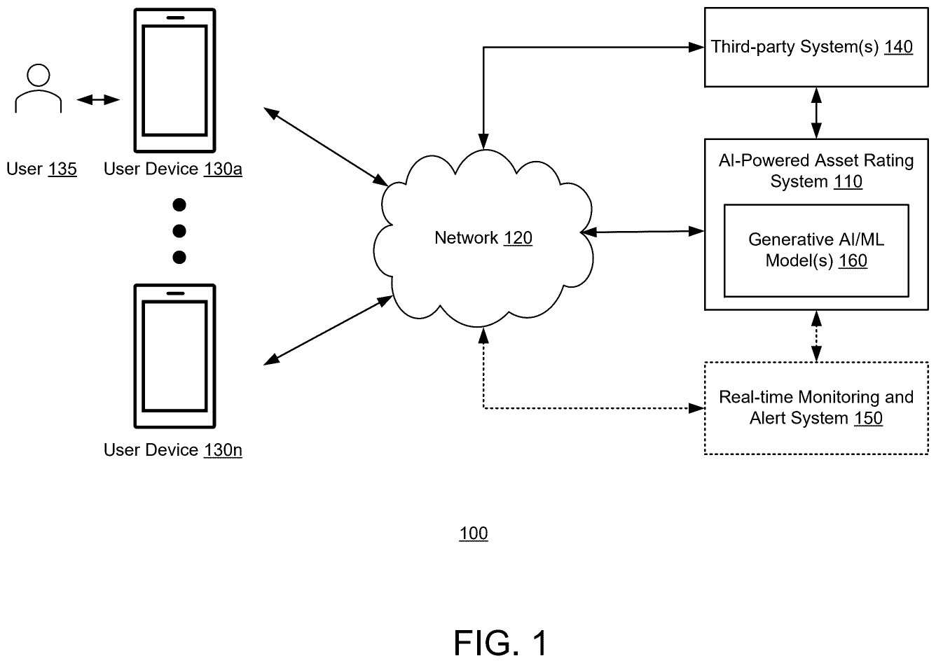

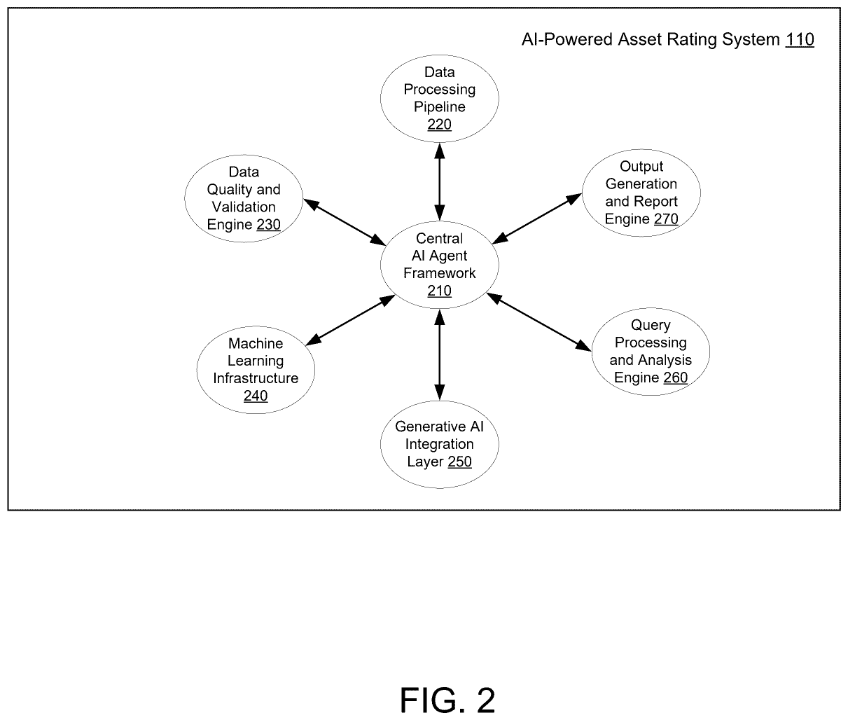

FIG. 2 illustrates example components included in the AI-powered asset rating system 110. As illustrated in the figure, the AI-powered asset rating system 110 includes a central AI agent framework 210, a data processing pipeline 220, a data quality and validation engine 230, a machine learning infrastructure 240, a generative AI integration layer 250, a query processing and scenario analysis engine 260, and an output generation and reporting engine 270. In some embodiments, the AI-powered asset rating system 110 may further include.

The central AI agent framework 210 represents the intelligent core of the system, functioning as a sophisticated digital assistant that orchestrates all aspects of the credit rating process without requiring constant human supervision. The GenAI agent serves as the central coordinator that can either look up companies (without heavy agent use) or interact directly with users, automatically utilizing all available tools. The agent knows where to grab data, how to extract it, and can handle cases where data is not immediately available. The system is built around this agent as the central hub. When a user asks a question about a company's credit rating, the agent immediately understands what information is needed and automatically begins gathering data from the most appropriate sources. If certain data is missing or temporarily unavailable, the agent doesn't simply give up. Instead, it intelligently seeks alternative sources or waits for the information to become available (e.g., through an alerting mechanism described elsewhere in the disclosure), ensuring that users receive complete and accurate responses. The agent operates with a level of autonomy that allows it to make decisions about which tools to use and in what sequence, eliminating the need for users to manually navigate complex systems or understand the technical details of data retrieval and processing.

The AI-powered credit rating agent enables end-to-end integration of multiple components of the rating system to work seamlessly together, performing functions including interpreting user inputs, extracting and spreading financials, generating and organizing research, translating research into projected financials, assigning risk scores to other credit relevant events, running ML rating models on new financials (or on entire structures for ABS), and clearly explaining rating results. The agent's coordination functions represent a complete automation of what traditionally required multiple specialists working in sequence. When a user submits a request, the agent first interprets what they're asking for, whether it's a simple rating lookup or a complex scenario analysis. It then automatically extracts financial data from documents, organizes this information into standardized formats that the machine learning models can process, and conducts additional research to gather relevant context about market conditions or industry trends. The agent seamlessly translates this research into quantitative inputs for financial projections, assigns appropriate risk scores to various events or factors that could impact creditworthiness, and runs these updated financials through sophisticated machine learning models to generate new ratings. Perhaps most importantly, the agent doesn't just produce numbers, it provides clear, understandable explanations of how it arrived at its conclusions, making the complex analytical process transparent and actionable for human decision-makers. This end-to-end integration means that what once required days or weeks of manual work by multiple specialists can now be completed in minutes or hours by a single intelligent system.

The data processing pipeline 220 functions as the system's comprehensive data management engine, capable of simultaneously handling multiple streams of information that arrive in vastly different formats and from diverse sources. The regulatory data may include regulatory filing data associated with a specific financial institution. The unstructured data may include data that lacks a specific format such as news, specific asset terms, document images, etc. Structured data may include data that are defined, organized, and searchable, such as asset prices, asset trades, structured asset terms, etc. This multi-stream approach allows the system to process everything from formal SEC filings and organized financial databases to informal news articles and even scanned document images simultaneously. The pipeline acts like a sophisticated sorting and processing facility that can handle structured information such as stock prices and trading volumes, which arrive in neat, organized formats, alongside completely unstructured information like news articles, press releases, or even handwritten documents that have been scanned into digital format. This comprehensive data ingestion capability ensures that the credit rating system has access to the full spectrum of information that could potentially impact an entity's creditworthiness, rather than being limited to traditional financial data sources.

The system uses intelligent workflows to process regulatory data by performing data quality check and data cleaning. Data quality check can ensure accurate and reliable data by assessing whether data is up-to-date, identifying missing data, detecting duplicate data, determining whether data is within a reasonable range, etc. Data cleaning allows the system to rectify faults or inconsistencies in the data by removing duplicate or irrelevant data, filtering undesired outliers, fixing errors in type conversion and syntax, etc. The intelligent workflow processing component operates like a meticulous quality control department that automatically examines every piece of incoming data for potential problems before allowing it to influence rating decisions. This system checks whether information is current and relevant, identifies gaps where important data might be missing, and spots duplicate entries that could skew analysis results. When the system finds problems, it doesn't simply reject the data. Instead, it actively works to fix issues by removing duplicates, correcting formatting errors, and filtering out information that appears to be incorrect or irrelevant. This automated quality assurance process ensures that the credit rating models operate on clean, reliable data, which is essential for producing accurate and trustworthy ratings.

During data preparation, the system may also perform default extraction using one or more AI models with intelligent workflows. The system applies unique scripts that make use of machine learning (such as natural language processing) and generative AI to automatically extract and structure the information. The generative AI models can be open-source models (such as Llama® models and the like) and closed-source models (such as OpenAI models® and the like). The advanced data extraction capability represents the system's most sophisticated processing function, utilizing cutting-edge artificial intelligence to automatically read and understand complex documents with great speed and consistency. This component can process lengthy financial reports, legal documents, news articles, and other text-heavy sources to identify and extract the specific pieces of information that are relevant for credit analysis. The system employs both publicly available AI models and proprietary commercial models to ensure it has access to the most advanced language understanding capabilities available. Rather than requiring human analysts to manually read through hundreds of pages of documents to find key financial metrics or risk factors, the AI extraction system can automatically identify, extract, and convert this information into structured formats that the rating models can immediately use, dramatically reducing the time required for comprehensive credit analysis while improving accuracy and consistency.

The data quality and validation engine 230 serves as the system's quality control mechanism, automatically checking and cleaning all incoming information before it can be used in rating calculations. The system uses intelligent workflows to process regulatory data by performing data quality check and data cleaning. Data quality check can ensure accurate and reliable data by assessing whether data is up-to-date, identifying missing data, detecting duplicate data, determining whether data is within a reasonable range, etc. This component works like a sophisticated filter that examines every piece of data entering the system, checking for common problems such as outdated information, missing values, or numbers that seem unrealistic compared to historical patterns. The system automatically flags suspicious data points and can either correct obvious errors or alert human operators when manual review is needed, ensuring that only reliable information feeds into the rating models.

Data cleaning allows the system to rectify faults or inconsistencies in the data by removing duplicate or irrelevant data, filtering undesired outliers, fixing errors in type conversion and syntax, etc. The validation process goes beyond simple error detection to actively improve data quality through automated correction procedures. For example, if the system receives the same financial report from multiple sources with slight formatting differences, it can identify these duplicates and consolidate them into a single, standardized record. The system removes OAS outlier records that could distort model training by checking for circumstances such as very short maturity, extremely high option value, and perpetuals, demonstrating how the validation component protects the integrity of the rating models by filtering out data points that, while potentially accurate, could mislead the machine learning algorithms. This comprehensive approach to data validation ensures that the AI-powered rating system operates on a foundation of clean, consistent, and reliable information, which is essential for producing accurate and trustworthy credit ratings.

The machine learning infrastructure 240 operates as a sophisticated analytical engine composed of multiple specialized artificial intelligence models, each designed to excel at evaluating specific types of financial entities and market conditions. The system uses multiple AI models, where each model may cover a specific asset class, a specific segment, a specific time period, and/or the combination thereof. AI models may be built for all five classes on which an NRSRO can issue a credit rating, i.e., corporates, financial institutions, insurance companies, asset-backed securities, and governments. Rather than using a single, one-size-fits-all approach, this infrastructure recognizes that different types of entities have fundamentally different risk characteristics that require specialized analytical approaches. For example, a model designed to evaluate corporate credit risk focuses on factors like revenue stability, debt levels, and market competition, while a model for financial institutions emphasizes different factors such as loan portfolio quality, regulatory capital ratios, and interest rate exposure. This multi-model approach ensures that each type of entity is evaluated using the most appropriate analytical framework, leading to more accurate and nuanced credit assessments than would be possible with a generic model attempting to handle all entity types.

The system incorporates several specialized model components that work together to provide comprehensive risk assessment capabilities. Where applicable, the simulation model is calibrated to determine credit risk, real-time pricing model is calibrated to determine a dynamic price for an asset (bond), and the system employs a synthetic asset pricing model to generate synthetic asset pricing data, for example, for entities without tradable debt. The in-sample and out-of-sample calibration may reduce overfitting. In addition, the simulation model may act like a sophisticated stress-testing engine that can model how various economic scenarios or company-specific events might impact an entity's ability to meet its financial obligations. The real-time pricing model continuously monitors market conditions to provide up-to-the-minute valuations of bonds and other debt instruments, ensuring that credit assessments reflect current market perceptions of risk. Perhaps most innovatively, the synthetic asset pricing model can create realistic pricing estimates for entities that don't have publicly traded debt, such as private companies or new issuers, by analyzing similar entities and market conditions to generate proxy pricing data that enables comprehensive credit analysis even when direct market data is unavailable.

The system determines the direction of credit impact for each feature, interactively removes level features that have minimal impact to reduce the effect of company size, clips extreme feature values to mitigate overfitting/sharp edges, and automatically detects sharp edges from features in model results using ICE plots. The feature engineering software functions as an intelligent data preparation system that automatically optimizes how information is presented to the machine learning models to ensure the most accurate possible results. This component analyzes each piece of input data to determine whether it represents a positive or negative credit factor, helping the models understand the directional impact of various financial metrics and market conditions. The system also automatically identifies and removes data points that might bias the analysis toward larger or smaller companies, ensuring that credit assessments are based on genuine risk factors rather than simply company size. To prevent the models from being misled by extreme or unusual data points that might not represent typical conditions, the system automatically adjusts outlier values and uses advanced analytical techniques such as ICE plots to identify and correct potential model weaknesses. This sophisticated feature engineering ensures that the machine learning models operate on optimized, clean data that enables them to identify genuine patterns and relationships rather than being distracted by irrelevant variations or statistical noise.

The generative AI integration layer 250 serves as the system's intelligent communication and information synthesis engine, enabling users to interact with complex credit rating data and models through natural, conversational interfaces. The rating agent integrates with the retrieval augmented generation (RAG) framework. This gives users (through the agent) the ability to more efficiently find credit relevant information within structured or unstructured data, as well as pre-extracting relevant details around an issuer's capital structure or details on existing or planned issues. The RAG framework functions like an exceptionally knowledgeable research assistant that can instantly search through vast amounts of financial documents, reports, and data to find exactly the information users need. When a user asks a question about a company's capital structure or wants to understand specific details about a bond issuance, the system doesn't just perform a simple keyword search. Instead, it understands the context and intent behind the question and retrieves the most relevant information from across all available data sources. This capability is particularly powerful because it can simultaneously search through structured databases containing organized financial metrics and unstructured documents like annual reports, press releases, and regulatory filings, providing users with comprehensive answers that would traditionally require hours of manual research across multiple systems and document types.

GenAI may be applied to clearly explain model results in plain language in real-time. The system may also conduct entity credit-related news distillation with GenAI, that is, by using the GenAI pipeline to synthesize credit-related news in real time for the specific entity.

The system may use the GenAI pipeline to enable users to converse with the models and further query on credit-related matters. The natural language processing component transforms the system from a technical analytical tool into an accessible, conversational platform that can communicate complex financial concepts in clear, understandable language. Rather than presenting users with raw numerical outputs or technical jargon, the system automatically generates plain explanations of what the credit rating results mean, why certain factors influenced the rating, and what key risks or strengths were identified in the analysis. The system also continuously monitors news and market developments related to specific entities, automatically filtering and summarizing only the information that could materially impact credit quality, saving analysts from having to manually sift through hundreds of news articles to identify relevant developments. More importantly, users can engage in ongoing conversations with the system, asking follow-up questions, requesting clarification on specific points, or exploring hypothetical scenarios, creating an interactive analytical experience that feels more like consulting with an expert colleague than operating a traditional software application.

The query processing and scenario analysis engine 260 functions as the system's intelligent command center, automatically understanding what users are asking and determining the most appropriate way to respond based on the complexity and nature of each request. An agent routes queries including: 1. Simple what-if. 2. Complex what-if. 3. Questions not requiring what-if. 4. Inappropriate or unrelated questions. This intelligent routing system works like a sophisticated receptionist who can instantly categorize incoming requests and direct them to the right department for handling. When a user asks a straightforward question about an existing credit rating, the system recognizes this as a simple information request and provides a direct answer from its database. For basic hypothetical questions like “What would happen if this company's revenue increased by 10%,” the system identifies this as a simple what-if scenario and can quickly calculate the impact using standard analytical procedures. However, when users pose complex multi-layered questions such as “How would a combination of rising interest rates, supply chain disruptions, and new regulatory requirements affect this portfolio of companies,” the system recognizes this as requiring sophisticated scenario modeling and automatically engages its most advanced analytical capabilities. The system also protects users from wasting time by identifying questions that fall outside its scope of expertise and politely redirecting them toward more productive inquiries.

For a sophisticated scenario analysis, the query processing and scenario analysis engine 260 first develops a comprehensive plan for how to approach the problem, identifying what information it needs to gather and which analytical tools it should employ. It then automatically begins executing this plan by searching the internet for relevant market data, analyzing uploaded documents for company-specific information, and reviewing regulatory filings for additional context. The engine seamlessly coordinates between different analytical tools, ensuring that when it estimates costs or revenue impacts, these changes are properly reflected throughout the entire financial model rather than being treated in isolation. The final step involves running these updated financial projections through the machine learning credit models to generate new ratings, creating a complete end-to-end analysis that shows not just the final result but also provides detailed explanations of how each step in the scenario contributed to the overall outcome. This automated execution capability means that complex analyses that might traditionally require days of work by multiple specialists can be completed in minutes while maintaining the thoroughness and accuracy of manual analysis.

The output generation and reporting engine 270 serves as the system's comprehensive communication hub, designed to deliver credit rating insights and analysis through multiple channels to accommodate the diverse needs and preferences of different users and organizations. A consumer or user may have the ability to interact with the system and consume the content generated by models in different ways, such as a UI (web-based UI), API, data feeds/flat files, notifications (text and/or email), applications (IOS or Android Apps), and/or Excel/G-Sheet plugins. This multi-format approach recognizes that different users work in different environments and have varying technical requirements for accessing information. Portfolio managers might prefer to receive automated alerts via email when ratings change, while quantitative analysts might need direct API access to integrate rating data into their own analytical systems. Traders working on mobile devices can access real-time updates through dedicated smartphone applications, while risk managers conducting detailed analysis might prefer to work with data directly in Excel spreadsheets through specialized plugins. The system automatically formats the same underlying analytical results appropriately for each delivery method, ensuring that whether a user is viewing results on a web dashboard, receiving a text message alert, or downloading data files, they receive accurate, up-to-date information presented in the most useful format for their specific workflow and technical environment.

The system's comprehensive analytics components work together to provide users with complete, actionable insights rather than just raw numerical ratings. The system provides a credit assessment at an entity and portfolio level. This credit assessment may be presented to a user along with an explanation. This explanation may be a GenAI-driven explanation generated based on SHapley Additive exPlanations (SHAP) values, ICE plots, and partial dependence plots (PDPs). Rather than simply stating that a company has a particular credit rating, the system automatically generates detailed explanations of why that rating was assigned, which factors were most influential in the decision, and how different variables contributed to the overall assessment. The present model pipeline may also develop and leverage SHAP (e.g., SHapley) over time technique to facilitate the illustration of feature attribution over time. The illustration may be both numerical and in chart form.

The system provides exhaustive distillation of news that materially affect credit/risk assessment. GenAI and data processing pipelines are applied to obtain the news distillation. The news distillation component continuously monitors thousands of news sources and automatically identifies and summarizes only those developments that could meaningfully impact credit quality, saving users from having to manually track market developments while ensuring they stay informed about relevant events. The system provides a what-if analysis. The system formulates guided trials by applying GenAI pipelines using credit assessment, distillation news, and credit model runs. The what-if analysis capability enables users to explore hypothetical scenarios by asking questions in natural language and receiving comprehensive analyses that show not only the potential rating impact but also the reasoning behind the projections, helping users understand the potential consequences of various business decisions or market developments before they occur.

In some embodiments, the above described each component 210-270 may be implemented in a high-level procedural or object-oriented programming language to communicate with a computer system, though programs may be implemented in assembly or machine language if desired. The language may be compiled or interpreted, with each computer program preferably stored on storage media or a device readable by a programmable computer for implementing the described functions of these components.

This comprehensive architecture enables the system to implement the disclosed technical solution through coordinated hardware and software components that provide automated, real-time credit risk assessment with unprecedented accuracy and analytical depth.

### Specific Implementations

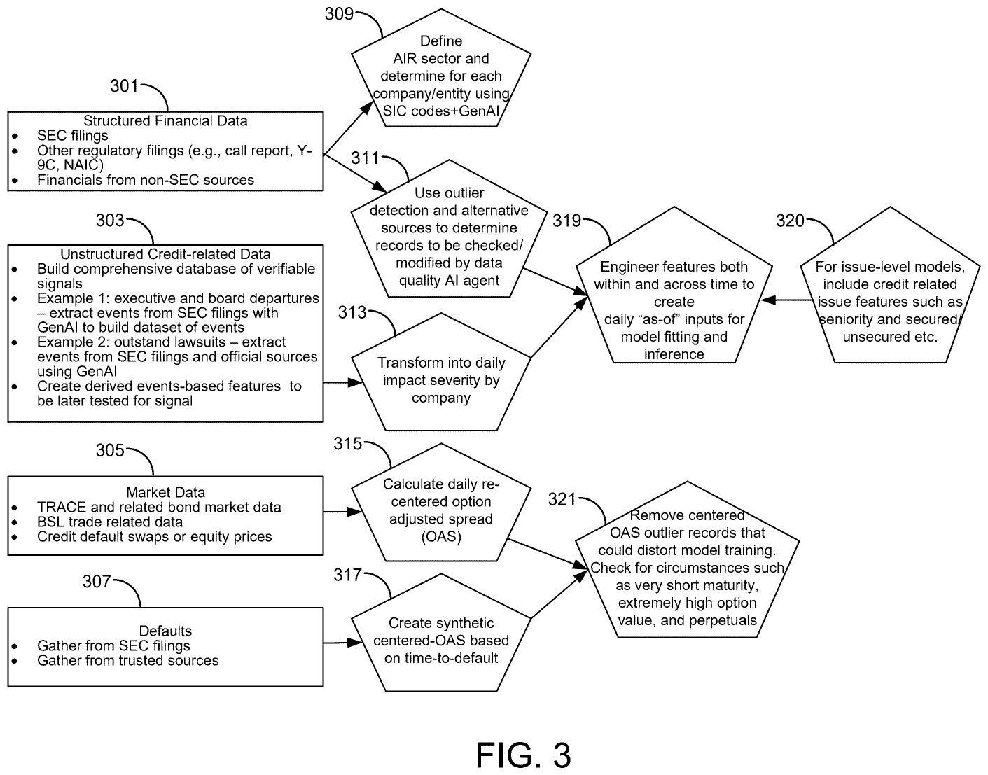

FIG. 3 is a flow diagram illustrating an example data pipeline processing in the AI-powered asset rating system, according to some embodiments.

Step 301 is positioned at the beginning of the structured financial data stream, which includes SEC filings, other regulatory filings (e.g., call report, Y-9C, NAIC), and financials from non-SEC sources. This step represents the entry point for collecting and processing quantitative financial information that comes in standardized, organized formats. The structured financial data stream flows from step 301 through to step 311, handling regulatory filings, financial statements, and other organized financial information that follows specific reporting formats and accounting standards.

Step 309 serves as the foundational classification step that establishes the organizational framework for processing structured financial data throughout the entire AI-powered asset rating system. Step 309 involves defining AIR sector and determining for each company/entity using standard industrial classification (SIC) codes and GenAI, which creates the essential categorization structure that determines how structured financial data will be collected, processed, and analyzed for each entity within the system's universe. This classification framework is particularly critical for structured financial data processing because different industry sectors have fundamentally different financial reporting requirements, accounting standards, regulatory oversight, and risk characteristics that are to be properly understood and accounted for in the data processing pipeline.

The relationship between step 309 and structured financial data processing is evident in how the AIR sector definitions guide the data collection and analysis steps. The structured financial data includes SEC filings, other regulatory filings (e.g., call report, Y-9C, NAIC), and financials from non-SEC sources, and the sector classifications established in step 309 determine which specific types of regulatory filings are most relevant for each entity, which financial metrics should be prioritized, and which industry-specific accounting treatments need to be considered. For example, financial institutions classified under appropriate AIR sectors would have their call reports and Y-9C regulatory submissions processed with particular attention to banking-specific metrics like loan loss provisions, tier 1 capital ratios, and net interest margins, while insurance companies would have their NAIC filings analyzed with a focus on reserve adequacy, solvency ratios, and underwriting performance. The GenAI component of the classification system enhances this process by identifying entities that may operate across multiple sectors or have evolved beyond traditional industry boundaries, ensuring that their structured financial data is processed using the most appropriate analytical framework.

Step 311 involves using outlier detection and alternative sources to determine records to be checked/modified by data quality AI agent, functioning as the critical quality assurance checkpoint for all structured financial information processed through the data pipeline. The data quality AI agent systematically examines the structured financial data for anomalous patterns, extreme values, or inconsistencies that could indicate data errors or exceptional circumstances requiring investigation. When potential issues are identified, the data quality AI agent automatically consults alternative sources to cross-validate findings, ensuring that corrections are based on reliable external verification rather than algorithmic assumptions alone.

The data quality AI agent store changes to only modify data until original source is fixed. That is, rather than permanently altering the original financial data, the system creates temporary modifications that allow analytical processes to continue uninterrupted while maintaining the ability to revert to corrected source data when upstream fixes become available. This approach recognizes that data quality issues often originate from external regulatory filing systems or third-party data providers, and permanent modifications could create inconsistencies when source corrections are eventually implemented. The relationship between step 301 and step 311 thus represents the complete lifecycle of structured financial data within the system, from initial collection of standardized regulatory and financial information through final validation and quality assurance, ensuring that the AI-powered rating system operates on a foundation of clean, consistent, and reliable data essential for producing accurate credit assessments.

Step 303 represents the beginning of the unstructured credit-related data processing stream within the AI-powered asset rating system, serving as the entry point for collecting and analyzing qualitative information that lacks standardized formatting but may significantly impact credit assessments. The unstructured credit-related data processing involves building a comprehensive database of verifiable signals, with examples including executive and board departures extracted from SEC filings using GenAI, and outstanding lawsuits extracted from SEC filings and official sources. This step initiates the systematic collection of event-driven and qualitative information that traditional financial statement analysis might miss but that could be crucial indicators of changing credit risk profiles.

The scope of step 303 encompasses a wide range of unstructured information sources that require sophisticated processing techniques to extract meaningful credit signals. The unstructured data may include data that lacks a specific format such as news, specific asset terms, document images, etc. This step involves deploying GenAI capabilities to automatically scan and analyze diverse sources including news articles, press releases, legal documents, regulatory correspondence, management communications, and other text-heavy sources that contain potentially relevant credit information. The system may be capable of processing everything from formal SEC filing narratives to informal news reports, from scanned document images to social media communications, ensuring that no potentially relevant credit signal is overlooked due to formatting limitations or source diversity.

Step 303 also establishes the foundation for transforming unstructured information into quantifiable risk signals that can be integrated with the structured financial data processing stream. The system transforms this information into daily impact severity by company and creates derived event-based features to be later tested for signal strength. This transformation process involves not just extracting relevant information from unstructured sources, but also categorizing events by their potential credit impact, assigning severity scores based on historical patterns, and creating standardized data formats that enable systematic analysis. For example, when the system identifies an executive departure through news analysis, step 303 ensures that this event is properly categorized (such as voluntary vs. involuntary departure, C-suite vs. lower-level management), assigned an appropriate impact severity score based on historical precedents, and formatted for integration with other credit-relevant data streams. This comprehensive approach to unstructured data processing ensures that the AI-powered rating system can capture and analyze the full spectrum of information that might influence creditworthiness, going far beyond traditional financial metrics to include the qualitative factors that often provide early warning signals of credit deterioration or improvement.

Step 313 represents the actual data transformation phase that converts event-based unstructured credit information into a standardized daily time series format suitable for machine learning model input. The transformation process takes complex, irregularly-timed events such as executive and board departures extracted from SEC filings with GenAI and outstanding lawsuits extracted from SEC filings and official sources using GenAI, and converts them into a binary daily impact framework where each company receives a daily severity score. The daily impact severity transformation creates a standardized temporal representation where the system assigns a value of 1 for days when a credit-relevant event impacts a specific company and 0 for all other days when no significant events affect that entity. This binary encoding enables the system to engineer “features both within and across time to create daily ‘as-of’ inputs for model fitting and inference”, ensuring that the machine learning models can process event-driven credit signals in a consistent temporal framework. The transformation process involves not only temporal standardization but also creating “derived events-based features to be later tested for signal”, which means that complex unstructured events like executive departures or lawsuit announcements are distilled into quantifiable daily impact indicators that can be systematically analyzed for their predictive value in credit risk assessment. This approach allows the AI-powered rating system to incorporate the timing and severity of unstructured credit events into its daily analytical framework, ensuring that qualitative information extracted from news, filings, and other unstructured sources can be effectively integrated with quantitative financial data for comprehensive credit analysis.

Step 320 represents a comprehensive data processing completion point that includes credit related issue features such as seniority and secured/unsecured characteristics for issue-level models, which focus on specific debt instruments (also referred to as issues) that the entity has created, such as bonds, loans, or notes. The step serves as a critical convergence point where various types of credit-relevant information are consolidated and enhanced with specific debt instrument characteristics that are essential for accurate issue-level credit assessment. This approach ensures that the feature engineering process in step 319 captures both entity-level and issue-specific risk factors that may significantly impact credit assessments. Step 320 incorporates detailed analysis of specific debt instrument features from multiple data sources, whether structured financial data, unstructured credit-related information, or market data, to identify and categorize critical issue-specific characteristics such as seniority ranking, collateral security, guarantee structures, covenant provisions, and other contractual features. This comprehensive approach recognizes that different debt instruments from the same issuer can have dramatically different risk profiles based on their structural characteristics, and step 320 ensures that these distinctions are properly captured and quantified across all relevant data streams before flowing into the final integration phase at step 319.

Step 319 serves as the critical feature engineering stage where raw financial, market, and textual data are systematically transformed into structured variables suitable for credit modeling. At this stage, the system creates features that capture both “within-time” characteristics, such as leverage ratios, coverage metrics, or bond spreads on a given date, and “across-time” dynamics, such as rolling averages, volatility measures, or changes in revenue and expenses over successive periods. By incorporating both static snapshots and temporal trends, step 319 ensures that the models can recognize not only the current state of a borrower's credit profile but also the trajectory and momentum of key indicators. This dual perspective allows the system to detect subtle signals of credit deterioration or improvement that might be missed if only point-in-time data were considered.

An equally important function of step 319 is aligning all these engineered features into consistent daily “as-of” datasets. Because credit analysis requires precision in timing, the system harmonizes inputs from multiple sources, such as quarterly financial statements, monthly regulatory filings, and high-frequency market data, into a synchronized daily view. Each day is thus represented by a complete feature vector for every issuer or debt instrument, enabling both historical backtesting and real-time inference. For model training, these daily as-of datasets are paired with known credit events or rating outcomes to fit machine learning models; for inference, they are generated on an ongoing basis to provide up-to-date credit scores and risk assessments. In this way, step 319 functions as the backbone of the modeling pipeline, ensuring that credit models always operate on timely, comprehensive, and properly structured information.

The model target data processing for training represents another role of the disclosed data pipeline to creating reliable training targets for the machine learning models by combining market-based pricing signals with historical default information. This process is specifically detailed through the interconnected steps 305, 315, 307, 317, and 321, which together create a comprehensive framework for generating accurate and representative training data that enables the AI-powered rating system to learn from both market intelligence and actual credit outcomes.

Step 305 initiates the market data stream, processing trade reporting and compliance engine (TRACE) and related bond market data, broadly syndicated loan (BSL) trade related data, as well as credit default swaps and equity prices. This foundational step establishes the market data collection framework that provides real-time and historical pricing information essential for creating market-based training targets. The TRACE data provides comprehensive transaction-level information about corporate bond trades, including prices, yields, and spreads that reflect market participants' collective assessment of credit risk. This market-based information serves as a crucial component of the training target generation process because it captures the market's real-time evaluation of credit quality, providing an objective benchmark against which the machine learning models can be trained and validated. The step also processes BSL trade-related data as well as credit default swaps and equity prices, creating a multi-faceted view of market-based credit assessments across different debt instruments and market segments.

Step 315 calculates the daily option adjusted spread (OAS). This step transforms the raw market data collected in step 305 into standardized risk measures that account for embedded options and other structural features that could distort simple spread calculations. The option-adjusted spread calculation is critical for training target generation because it provides a normalized measure of credit risk that enables fair comparison across bonds with different structures, maturities, and embedded features. The daily calibration process ensures that the OAS measures are adjusted for prevailing market conditions and interest rate environments, creating training targets that focus on entity-specific credit risk rather than broader market movements. This standardization is essential for machine learning model training because it ensures that the models learn to identify genuine credit risk signals rather than being influenced by market-wide factors or structural bond characteristics.

It should be noted that the system disclosed herein is not limited to the OAS-mediated prediction described above, but can triangulate credit or other default risks (corporates, sovereigns/munis, structured, etc.) by modeling other factors as well. For example, credit default swaps (CDS), equity prices, option prices, capital ratios, and many other related metrics may be used for this purpose.

Step 307 focuses on gathering default data from SEC filings and trusted sources.

This step represents the beginning of the default data processing stream, where the system systematically collects information about corporate defaults, bankruptcies, and other credit events that serve as critical training data for the machine learning models. The system accesses both regulatory filings that document formal default events and trusted third-party sources that provide comprehensive default databases, ensuring that the models have access to complete historical default information necessary for accurate credit risk assessment.

By analyzing the relationship between time-to-default and market spreads for entities that have experienced defaults, step 317 generates synthetic training targets that expand the available training data while maintaining realistic market-based characteristics. This process leverages historical patterns observed in entities that progressed from performing status to default, using the time period between when market spreads began widening and when actual default occurred to establish predictive relationships. The synthetic OAS generation enables the training process to include a broader range of credit deterioration scenarios, improving the models' ability to identify early warning signals and assess entities across the full spectrum of credit quality.

Step 321 removes OAS outlier records that could distort model training by checking for circumstances such as very short maturity, extremely high option value, and perpetuals. This critical quality control step ensures that the training targets used for machine learning model development are representative of normal market conditions and credit relationships rather than being skewed by unusual circumstances or statistical anomalies. The systematic removal of outliers is essential for effective model training because machine learning algorithms can be disproportionately influenced by extreme values that don't represent typical credit risk patterns. By identifying and filtering out data points that represent unusual market conditions, such as bonds with very short time to maturity that might trade at unusual spreads due to liquidity concerns, bonds with extremely high embedded option values that create pricing anomalies, or perpetual bonds that have fundamentally different risk characteristics, step 321 ensures that the models learn from representative examples of credit risk rather than being misled by statistical outliers.

Step 321 represents the completion of the market data processing stream, following the OAS calculation and outlier removal steps, serving as the final preparation phase for training targets before they are integrated into the comprehensive model training framework. This step ensures that all market-based training targets are properly formatted, temporally aligned, and validated for use in the machine learning model development process. Step 321 also coordinates the integration of the market-based training targets with the default-based training data, creating a comprehensive training dataset that combines both market intelligence and actual credit outcomes. The completion of step 321 provides the model training process with high-quality, representative training targets that enable the AI-powered rating system to learn from both the objectivity of market pricing and the definitive outcomes represented by actual defaults and credit events.

The sequence of steps 305, 315, 307, 317, and 321 creates a sophisticated training target generation framework that addresses the key challenges in credit model development: data quality, representativeness, and comprehensiveness. By combining real market data with synthetic targets derived from default analysis, this process ensures that the machine learning models have access to training data that spans the full spectrum of credit conditions while maintaining the highest standards for data quality and market consistency. This comprehensive approach to training target generation enables the AI-powered asset rating system to develop models that are both statistically robust and practically relevant, capable of generating accurate credit assessments that reflect both fundamental credit analysis and market-based validation.

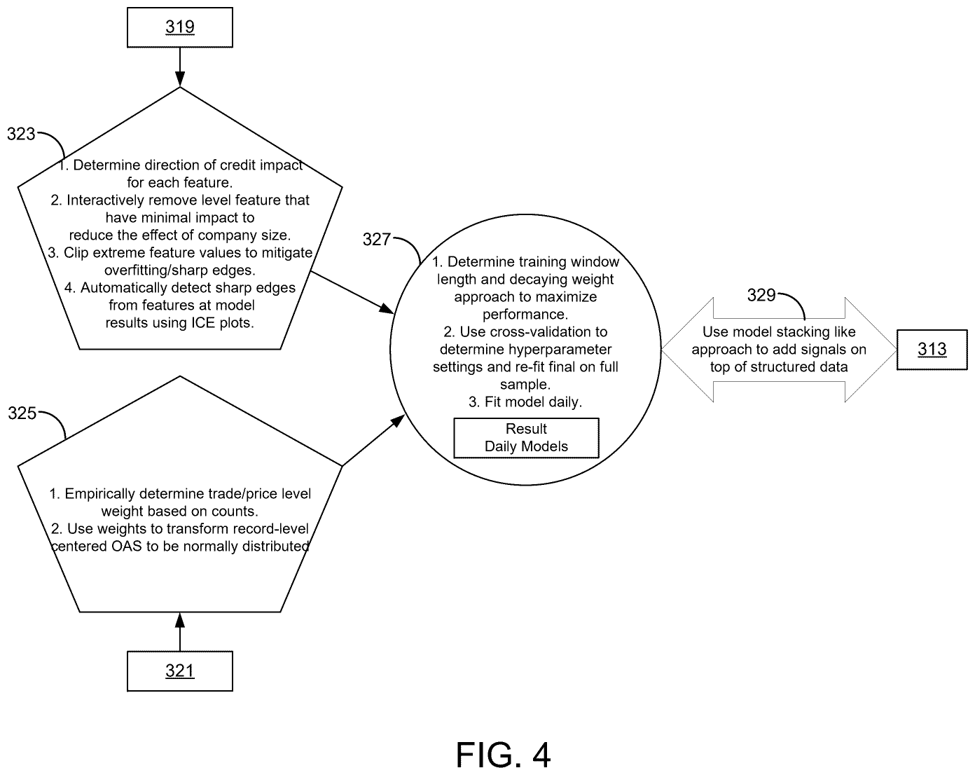

FIG. 4 is a flow diagram illustrating an example modeling pipeline processing in the AI-powered asset rating system, according to some embodiments. This figure represents the core analytical engine of the AI-powered asset rating system, where advanced feature engineering, model optimization, and training processes converge to create robust predictive models that can assess credit risk across diverse entity types and market conditions.

Step 323 involves four critical feature engineering processes: 1. Determine direction of credit impact for each feature. 2. Interactively remove level features that have minimal impact to reduce the effect of company size. 3. Clip extreme feature values to mitigate overfitting/sharp edges. 4. Automatically detect sharp edges from features at model results using ICE plots, and it is based on the comprehensive integrated dataset from step 319. Step 319 represents the critical convergence point where all three primary data streams—structured financial data, unstructured credit-related data, and market data—are integrated into a unified analytical framework, providing the foundation for the sophisticated feature optimization processes that occur in step 323.

Step 323 takes the multi-dimensional, integrated dataset from step 319 and applies advanced feature engineering techniques to optimize it for machine learning model training. The process begins by systematically analyzing each feature from the integrated dataset to determine whether it has a positive or negative relationship with credit risk, ensuring that the models understand the directional impact of variables derived from structured financial data, unstructured credit events, and market signals. The interactive removal of level features addresses the common problem where absolute company size effects can overwhelm genuine relative credit risk signals across all data types, ensuring that models focus on meaningful risk characteristics rather than scale differences. The clipping of extreme feature values prevents outliers from any of the three data streams from creating problematic model behavior, while the automated detection of sharp edges using ICE plots provides systematic identification of feature relationships that might compromise model performance. This comprehensive feature engineering approach ensures that the rich, multi-source dataset created in step 319 is transformed into clean, relevant inputs that maximize the predictive power of the machine learning models while maintaining statistical robustness and interpretability.

Step 325 empirically determines trade/price level weight based on counts and uses weights to transform record-level OAS to be normally distributed, and it is based on the processed market data from step 321. Step 321 represents the completion of the market data processing stream, following the OAS calculation and outlier removal steps, which provides the foundation for the advanced statistical transformations that occur in step 325.

The first component of step 325 involves analyzing the market data completed in step 321 to empirically determine appropriate weights based on actual trading activity and transaction counts. This process examines the frequency and volume of trades at different price levels to create intelligent weighting schemes that reflect real market liquidity and trading patterns. Price levels with higher trading volumes receive greater weight because they represent more reliable market consensus, while thinly traded price levels receive lower weights to prevent the analysis from being skewed by potentially anomalous transactions. The second component uses these empirically determined weights to transform the record-level OAS data into normally distributed variables, which is crucial for subsequent statistical analysis and machine learning model performance. This transformation ensures that the market data maintains appropriate statistical properties while reflecting the actual market structure and liquidity characteristics captured in the trading count analysis. The combination of empirical weighting and statistical normalization in step 325 creates optimized market data inputs that enable more accurate and reliable credit risk assessment in the subsequent modeling phases.

Step 327 represents the model training and calibration stage of the credit rating system. At this point, the system takes the fully engineered features from earlier steps and focuses on determining how best to fit the machine learning models so that they deliver accurate, stable, and generalizable predictions. The first part of this process involves defining an appropriate training window length and selecting a decaying weight scheme. The training window length establishes how much historical data is included in model fitting, while the decaying weight approach ensures that more recent data receives higher importance than older data. This reflects the fact that credit markets and issuer conditions evolve, so the system must balance long-term historical perspective with sensitivity to the latest signals. By carefully calibrating these parameters, step 327 maximizes predictive performance while avoiding both overfitting and stale insights.

The second part of step 327 uses cross-validation to optimize the model's hyperparameters, such as regularization strengths, learning rates, or tree depths (depending on the ML method). Through iterative testing, the system identifies the configuration that performs most robustly across different data folds, ensuring the model generalizes well to unseen data. Once optimal settings are found, the final model is re-fit on the full training sample to capture the maximum amount of information. The third and critical element of this step is that the model is re-trained on a daily basis. By fitting the model daily, the system adapts in near real time to new financial reports, market movements, or credit events, maintaining its accuracy and relevance. Together, these procedures make step 327 the engine that keeps the AI-powered credit models continuously calibrated, up to date, and ready for daily inference on both entity-level and issue-level credit risk.

Step 329 represents the model enhancement stage, where the system applies a “stacking-like” methodology to enrich predictions beyond what structured financial data alone can provide. Structured data, such as balance sheet ratios, income statement figures, and regulatory filings, forms the foundation of credit risk modeling, but on its own, it can miss more subtle, event-driven or forward-looking signals. In this step, the system layers additional features and models on top of the structured core to capture signals from unstructured credit-related data, market activity, or alternative datasets. For example, executive departures, legal actions, bond trading patterns, or sector-level trends can all be integrated as secondary models that feed into the main predictive engine. This stacked approach allows the credit system to combine the stability of structured financials with the adaptability and richness of alternative signals.

The stacking process works by first training baseline models on structured data and then using the predictions or residuals as inputs for higher-level models that incorporate new signals. Each layer adds incremental predictive power, with the stacked ensemble learning how to weight different inputs based on their relevance and reliability. By doing so, step 329 mitigates the risk of overreliance on any single data type and improves overall robustness. The result is a credit rating model that not only explains an entity's fundamental financial health but also reflects market sentiment, governance issues, and emerging risks in near real time. In essence, step 329 transforms the system into a multi-layered analytical framework where structured financial information is the backbone, but diverse additional signals refine and sharpen the predictive outcome.

While not shown, in some embodiments, the system disclosed herein may perform model segmentation to improve model results by breaking down the modeling for distinct segments of the data. For example, by using generative AI, the system disclosed herein may use unique sector segmentation to improve model performance. In some embodiments, the unique sectors may be expanded to other asset classes. For example, the system disclosed herein may create specific geographical & social economic sectors for Munis or mortgage-backed securities.

Moreover, the system disclosed herein also supports an end-to-end evolution mechanism with tracking and iterations. The system disclosed herein may track the progress of the rating generation during the iterations. In some embodiments, the system disclosed herein may apply track steps to automatically capture model outputs and metrics for each iteration, which then provides the ability to empirically prove whether the model performance has improved.

The workflow in FIG. 4 highlights the system's core analytical engine, where advanced feature engineering, market data optimization, and model training converge to produce daily-updated predictive models. By systematically integrating multi-source data, refining it through statistical transformations, and calibrating models with cross-validation and decaying weights, the system ensures both accuracy and adaptability across changing market conditions. The incorporation of stacking-like methodologies further enhances predictive performance by layering unstructured and event-driven signals on top of structured financial data. This comprehensive modeling pipeline enables the system to deliver robust, explainable, and continuously refreshed credit risk assessments across diverse issuers and instruments, providing a professional-grade analytical foundation for reliable credit rating applications.

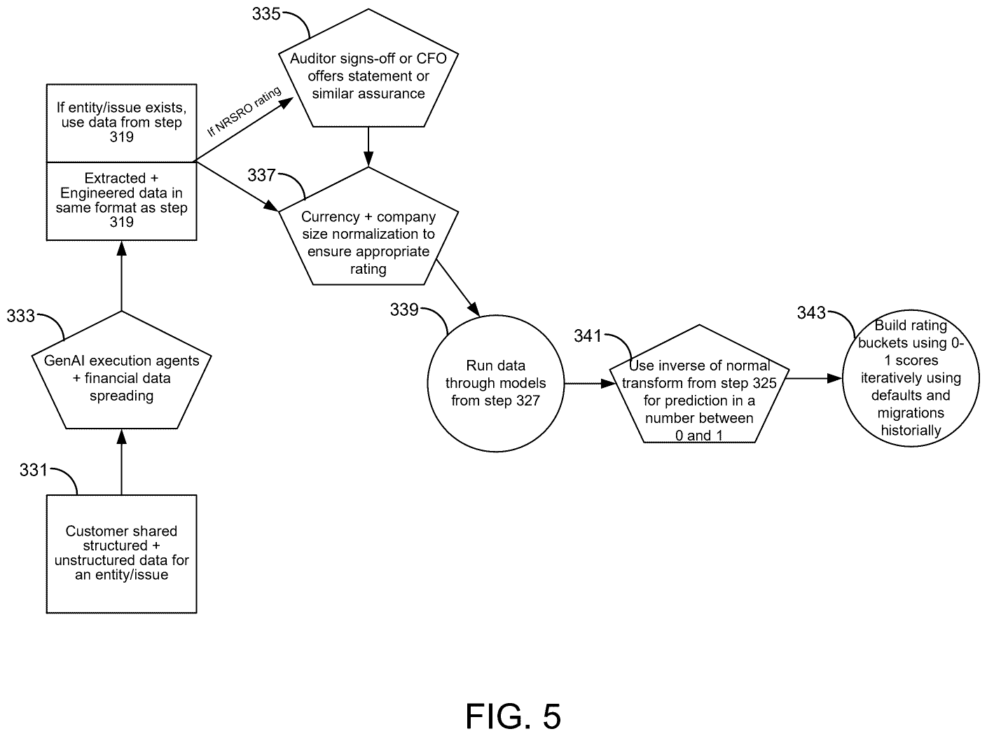

FIG. 5 is a flow diagram illustrating an example inference/scoring process in the AI-powered asset rating system, according to some embodiment.

The process begins by checking whether an entity/issue exists in the system. If the entity/issue exists, use data from step 319. In other words, the system leverages existing comprehensive data that has already been processed through the complete data integration pipeline described in FIG. 3. When an entity or issue already exists in the system's database, the established data from step 319 provides the foundation for analysis, ensuring consistency and reliability by utilizing the thoroughly validated and integrated dataset that combines structured financial data, unstructured credit-related information, and market data. This pathway maintains analytical integrity while avoiding potential conflicts or inconsistencies that could arise from mixing different data sources for the same entity.

On the other hand, when an entity or issue does not exist in the system's database, the workflow implements a comprehensive customer data processing pipeline. Step 331 handles customer shared structured and unstructured data for the entity/issue, establishing the entry point for external data integration. Step 333 employs GenAI execution agents and financial data spreading to automatically process the diverse formats and sources of customer-provided information, extracting relevant financial metrics and structuring unstructured data for analysis. This sophisticated AI-powered processing ensures that customer-provided data, regardless of its original format or source, is transformed into standardized inputs that can be seamlessly integrated into the system's analytical framework. The process results in extracted and engineered data in same format as step 319, ensuring that customer-provided information receives the same analytical treatment and maintains the same data quality standards as internally sourced data.

Following the data preparation, the workflow then implements a critical regulatory distinction based on whether the analysis is intended for NRSRO rating purposes. For NRSRO ratings, the process includes step 335, which requires the auditor signs-off or CFO offers statement or similar assurance, demonstrating the system's sophisticated approach to regulatory compliance and data validation. This additional validation step ensures that ratings intended for regulatory purposes meet the heightened standards required for NRSRO compliance, implementing appropriate verification procedures that provide confidence in the reliability and accuracy of the underlying data. The auditor sign-off or CFO statement requirement represents a critical quality control mechanism that bridges the gap between automated data processing and regulatory accountability, ensuring that human oversight and professional responsibility are maintained for official rating purposes.

For non-NRSRO applications, the workflow bypasses step 335 and proceeds directly from the data preparation phase to step 337, streamlining the process for internal analysis, portfolio management, or other non-regulatory applications while maintaining analytical rigor. Step 337 implements currency and company size normalization to ensure appropriate rating, which represents a critical standardization process that ensures fair comparison across entities of different sizes and operating in different currencies. This normalization step is essential for maintaining rating consistency and accuracy, particularly when dealing with international entities or when comparing companies of significantly different scales. The process continues through step 339, which runs data through models from step 327, and step 341, which uses invoice of normal transform from step 325 for prediction in a number between 0 and 1, applying the full machine learning infrastructure to generate numerical risk scores.

Specifically, step 339 represents the core model execution phase where the normalized and prepared data from step 319 or steps 331 and 333 is processed through the sophisticated machine learning infrastructure developed in the training optimization phase.

Step 327 established the optimal training framework including training window length, decaying weight approaches, cross-validation for hyperparameter settings, and daily model fitting capabilities. Step 339 takes the customer data that has been standardized through currency and company size normalization and applies these trained models to generate preliminary risk assessments. This step leverages the comprehensive model training infrastructure that incorporates the feature engineering from step 323, ensuring that customer-provided data receives the same sophisticated analytical treatment as internally sourced information through the fully optimized machine learning models.

It should be noted that during the model execution phase, the system extends its rating and monitoring framework to cover all five asset classes designated by the SEC under the NRSRO Act, applying consistent methodologies across entity types while tailoring risk assessments to category-specific characteristics. For corporate issuers, financial institutions, and insurance companies (Categories 1-3), the models align fundamental financial data with risks unique to each sector, for example, incorporating credit loss and interest rate exposure for banks, or insurance-specific liabilities for insurers. For asset-backed securities (Category 4), the methodology employs a two-step process: first, rating the quality of the underlying assets, such as individual loans in a CLO, and then evaluating the structure based on asset composition and diversification. For government, municipal, and foreign sovereign issuers (Category 5), the methodology applies largely as described for corporates, with the benefit of high transparency in government data. This structured yet flexible approach ensures that each asset class is rated and monitored in a way that reflects its distinct risk profile while maintaining methodological consistency across the NRSRO framework.

Step 341 represents the final prediction generation phase that applies the market data transformations developed in step 325 to convert model outputs into standardized probability scores or various other formats such as percentiles, ranks, basis points, or other predefined rating scales or levels. Step 325 established the empirical trade/price level weights based on transaction counts and implemented the statistical transformations that convert record-level OAS to normally distributed variables. Step 341 applies reverse transformation that essentially reverses the normalization process that was applied to the option-adjusted spread (OAS) data in step 325, ensuring that the final predictions maintain mathematical consistency with the underlying market-based risk measures while producing interpretable probability scores (e.g., generating numerical outputs between 0 and 1 that represent probability-based risk scores). This step ensures that customer-specific ratings benefit from the same market data insights and statistical normalizations that enhance the accuracy and reliability of all system outputs, creating standardized risk scores that can be directly compared with ratings generated for entities in the existing database and converted into traditional rating categories through the historical calibration process in step 343.

Step 343 represents the final calibration phase that converts the numerical probability scores from step 341 into traditional credit rating categories through sophisticated historical analysis. This step implements an iterative calibration methodology that leverages comprehensive historical data on actual defaults and credit migrations to establish the boundaries between different rating categories. The process analyzes patterns from historical credit events to determine the appropriate probability thresholds that correspond to traditional rating buckets (such as AAA, AA, A, BBB, etc.), ensuring that the AI-generated numerical scores are mapped to rating categories that accurately reflect historical default and migration patterns.

The iterative approach in step 343 represents a dynamic calibration process that continuously refines rating bucket boundaries based on expanding historical datasets and evolving credit market conditions. Rather than using static probability thresholds, the system analyzes historical default rates and migration patterns across different time periods and market cycles to establish rating boundaries that maintain consistency with observed credit performance. For example, if historical data shows that entities with probability scores between 0.02 and 0.05 experienced default rates consistent with BB-rated credits, the system would assign entities with similar scores to the BB rating bucket. The migration analysis component examines how entities moved between rating categories over time and/or location (e.g., differing risks in different locations at different times), ensuring that the bucket assignments reflect not only ultimate default outcomes but also the typical progression of credit deterioration or improvement. This comprehensive historical calibration ensures that the AI-powered rating system produces ratings that are both statistically rigorous and consistent with established credit rating conventions, enabling users to interpret and apply the ratings within familiar frameworks while benefiting from the enhanced accuracy and responsiveness of the machine learning-based analytical approach.

The workflow in FIG. 5 demonstrates the system's ability to handle diverse customer requirements, from processing new entity data to providing ratings for entities not currently covered in the system's database. The integration of GenAI execution agents, rigorous data validation procedures, and comprehensive model processing creates a seamless customer experience that delivers professional-grade credit ratings while accommodating the specific needs and data sources of individual customers. This capability significantly expands the system's utility and market coverage, enabling it to serve as a comprehensive credit analysis platform that can address virtually any customer requirement while maintaining the consistency and reliability that are essential for professional credit rating applications.

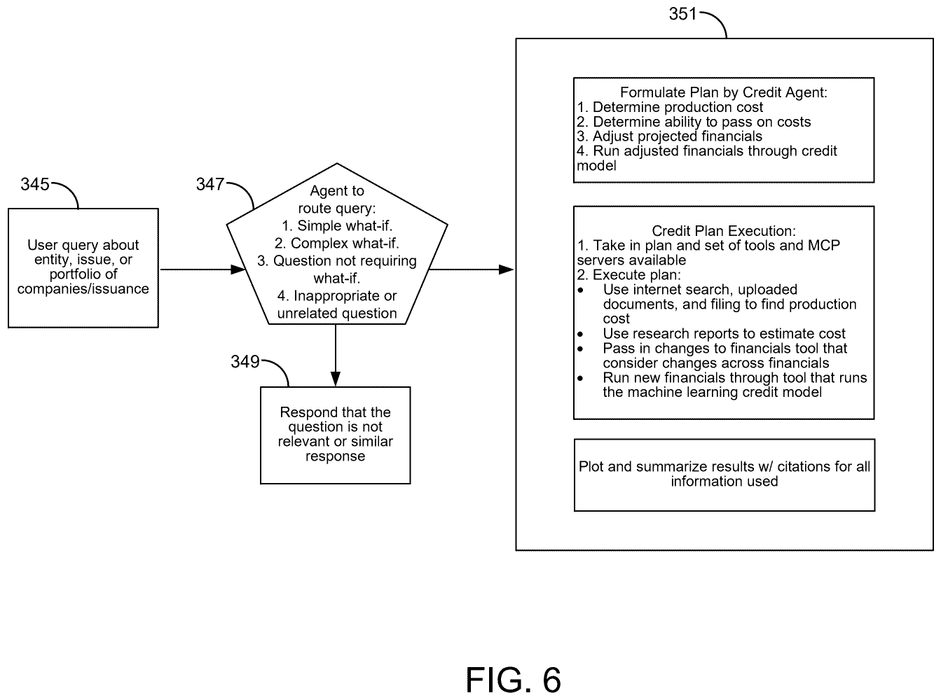

FIG. 6 illustrates the sophisticated query processing and scenario analysis capabilities of the AI-powered asset rating system, demonstrating how the system handles complex user inquiries and what-if analyses through intelligent agent-based routing and execution.

The process begins with step 345, where an agent receives a user query about entity, issue, or portfolio of companies/issuance, establishing the entry point for user interactions with the system's analytical capabilities. This intelligent routing mechanism represents a critical component that enables the system to understand and categorize different types of user requests, ensuring that each query receives appropriate analytical treatment based on its complexity and requirements.

The routing agent categorizes queries into four distinct types: 1. Simple what-if. 2. Complex what-if. 3. Question not requiring what-if. 4. Inappropriate or unrelated question. This sophisticated classification system demonstrates the system's ability to understand the nature and complexity of user requests, enabling it to apply appropriate analytical resources and methodologies. Simple what-if scenarios might involve straightforward parameter changes or single-variable adjustments, while complex what-if analyses could require comprehensive scenario modeling involving multiple interconnected variables and their cascading effects across financial statements and credit metrics. Questions not requiring what-if analysis would include straightforward inquiries about current ratings, historical performance, or comparative analysis and deeper research, while inappropriate or unrelated questions are filtered out to maintain system focus and efficiency.

For complex analytical requests, the system implements a comprehensive scenario analysis framework. Step 351 represents an example dynamic plan formulation and execution by the credit agent in handling an complex analytical request. As illustrated, the credit agent may dynamically formulate a plan with specific steps: 1. Determine production cost; 2. Determine ability to pass on costs; 3. Adjust projected financials; and 4. Run adjusted financials through credit model. This structured approach demonstrates the system's sophisticated understanding of business dynamics and credit analysis, recognizing that meaningful scenario analysis requires systematic consideration of operational factors, market conditions, and financial implications. The plan formulation process ensures that complex what-if scenarios are approached methodically, considering not just direct financial impacts but also secondary effects such as pricing power, competitive positioning, and market dynamics that could influence credit outcomes.

The credit plan execution phase includes: 1. Take in a plan and set of tools and model context protocol (MCP) servers available; 2. Execute the plan with specific capabilities including “Use internet search, uploaded documents, and filing to find production cost,” “Use research reports to estimate cost,” “Pass in changes to financial tools that consider changes across financials,” and “Run new financials through tool that runs the machine learning credit model”. This execution framework demonstrates the system's comprehensive analytical capabilities, combining multiple data sources and analytical tools to generate realistic scenario outcomes. The integration of internet search capabilities, document analysis, and research report utilization shows how the system leverages diverse information sources to ensure that scenario analyses are grounded in realistic market conditions and operational constraints. It is to be noted that, if no plan is needed, the agent may directly execute the last two steps without finding production cost or estimating the cost.

The final phase involves plot and summarize results with citations for all information used, demonstrating the system's commitment to transparency and analytical rigor in presenting scenario analysis results. This comprehensive output generation ensures that users receive not only the analytical conclusions but also full documentation of the data sources, assumptions, and methodologies used in the analysis. The citation requirement maintains professional standards and enables users to validate and understand the basis for the analytical conclusions, supporting informed decision-making and regulatory compliance.

For inappropriate or unrelated questions, step 349 responds that “the question is not relevant” or similar response, ensuring that the system maintains appropriate boundaries while providing helpful guidance to users. This filtering mechanism protects system resources while maintaining a professional user experience, directing users toward appropriate analytical applications while clearly communicating when requests fall outside the system's intended scope.

It should be noted that, under certain circumstances, even without a user query, the system disclosed herein may automatically run based on a schedule, or when a specific risk threshold is reached, so that a proper alert can be timely generated as described earlier.

The workflow in FIG. 6 demonstrates the system's scenario execution capabilities, where user queries, ranging from simple what-if questions to complex multi-step analyses, are automatically translated into structured execution plans. The scenario execution engine intelligently determines the required data inputs, analytical tools, and sequence of operations, then orchestrates the process using internet search, regulatory filings, research reports, and financial modeling tools. By coordinating updates to financial projections and seamlessly running them through machine learning credit models, the system generates end-to-end analyses that are both comprehensive and explainable. This workflow highlights the system's ability to function like an autonomous project manager, breaking down complex analytical tasks into manageable steps and delivering timely, high-quality results. The integration of automated planning, execution, and result visualization significantly enhances user experience, enabling professionals to obtain rigorous credit insights in minutes that would traditionally require days of manual effort.

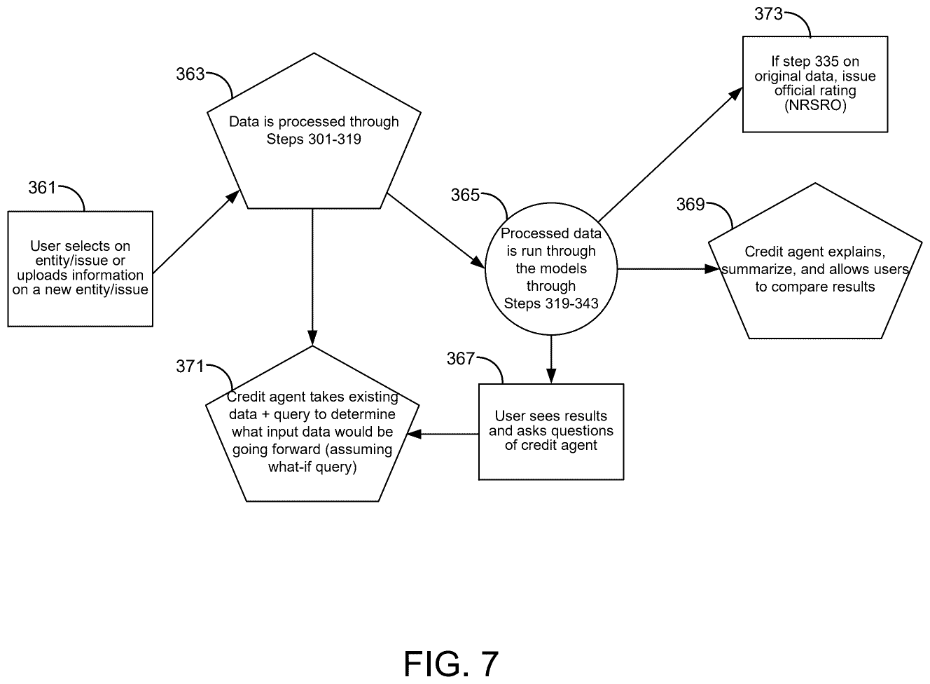

FIG. 7 represents the complete integration of all system components described in FIGS. 3-6, illustrating the end-to-end workflow from data processing through user interaction and rating generation. The process begins with step 361, where a user selects an entity/issue or uploads information on a new entity/issue, establishing the entry point for user engagement with the comprehensive analytical framework. This integrated workflow demonstrates how the sophisticated data processing pipelines, advanced modeling infrastructure, customer data integration capabilities, and intelligent query processing systems work together to deliver a seamless user experience that combines the analytical power of machine learning with the accessibility and interpretability required for professional credit analysis applications.

The system processes data through steps 301-319 (indicated by step 363 in FIG. 7), which encompasses the entire data processing pipeline described in FIG. 3, including the structured financial data stream, unstructured credit-related data stream, and market data stream. This comprehensive data processing phase ensures that all available information sources are systematically collected, validated, and integrated into the unified analytical framework established at step 319. The integration of these diverse data streams creates a multi-dimensional view of credit risk that incorporates traditional financial analysis, alternative data insights, and market-based validation, providing the foundation for accurate and comprehensive credit assessments.

Following data processing, processed data is run through the models through steps 319-343, which incorporates both the advanced modeling pipeline from FIG. 4 (steps 323-329) and the customer data integration and rating generation processes from FIG. 5 (steps 331-343). This modeling phase applies the sophisticated feature engineering, training optimization, and model stacking approaches developed through the machine learning infrastructure to generate numerical risk scores that are then converted into traditional rating categories through historical calibration. The integration ensures that whether data originates from internal sources or customer submissions, all entities receive the same rigorous analytical treatment through the optimized machine learning models.

The user interaction framework includes step 367, where a user may see results and ask questions of the credit agent, and step 369, where the credit agent explains, summarize, and allows users to compare results. In addition to providing a single entity view, the system disclosed herein allows users to view multiple entities at the same time. The system disclosed herein provides users the ability to compare the data of multiple entities, sign up for alerts related to each entity, etc. This interactive component integrates the intelligent query processing capabilities from FIG. 6, enabling users to engage with the analytical results through natural language queries and receive comprehensive explanations and comparisons. The credit agent functionality represents a sophisticated interface that combines the analytical power of the machine learning models with the interpretability and accessibility required for professional decision-making, enabling users to understand not just the rating conclusions but also the underlying factors and reasoning that support those conclusions.

For scenario analysis, step 371 shows how the credit agent takes existing data and query to determine what input data would be going forward (assuming what-if query), integrating the complex scenario analysis capabilities described in FIG. 6. This functionality enables users to explore hypothetical scenarios and understand how changes in business conditions, financial performance, or market factors might impact credit ratings. The integration of scenario analysis with the comprehensive data processing and modeling infrastructure creates a powerful analytical tool that enables proactive risk management and strategic planning while maintaining the accuracy and reliability of the underlying credit assessments.

Based on credit assessment, news distillation, and what-if analysis, the system disclosed herein may further generate a summary report. The summary report may be generated by GenAI pipelines to include credit memos, opinions, as well as portfolio reports. In some embodiments, the system disclosed herein may generate a customizable summary report in a credit memo format based on user requirements. The summary report may be presented to a user via a UI, data feed, API, notification, apps, plugins, etc.

For NRSRO applications at step 373, if step 335 is working on original data (i.e., data obtained through steps 331 and 333, issue official rating (NRSRO). This demonstrates the system's regulatory compliance capabilities, implementing appropriate validation and oversight procedures for official rating purposes. This regulatory pathway ensures that ratings intended for regulatory use meet the heightened standards required for NRSRO compliance while maintaining the efficiency and analytical sophistication of the AI-powered system. The distinction between regulatory and non-regulatory applications enables the system to serve diverse user needs while implementing appropriate quality controls and validation procedures based on the intended use of the rating results.

FIG. 7 demonstrates the successful integration of all system components into a cohesive analytical platform that delivers professional-grade credit analysis capabilities through an accessible and intuitive user interface. The workflow shows how sophisticated data processing, advanced machine learning, regulatory compliance, and intelligent user interaction combine to create a comprehensive solution that addresses the full spectrum of credit analysis requirements. The system's ability to handle both existing entities and new customer-provided data, accommodate both regulatory and non-regulatory applications, and support both standard rating generation and complex scenario analysis represents a significant advancement in credit analysis technology that maintains the highest standards for accuracy, transparency, and regulatory compliance while delivering unprecedented analytical capabilities and user accessibility.

System and/or Computer Embodiments

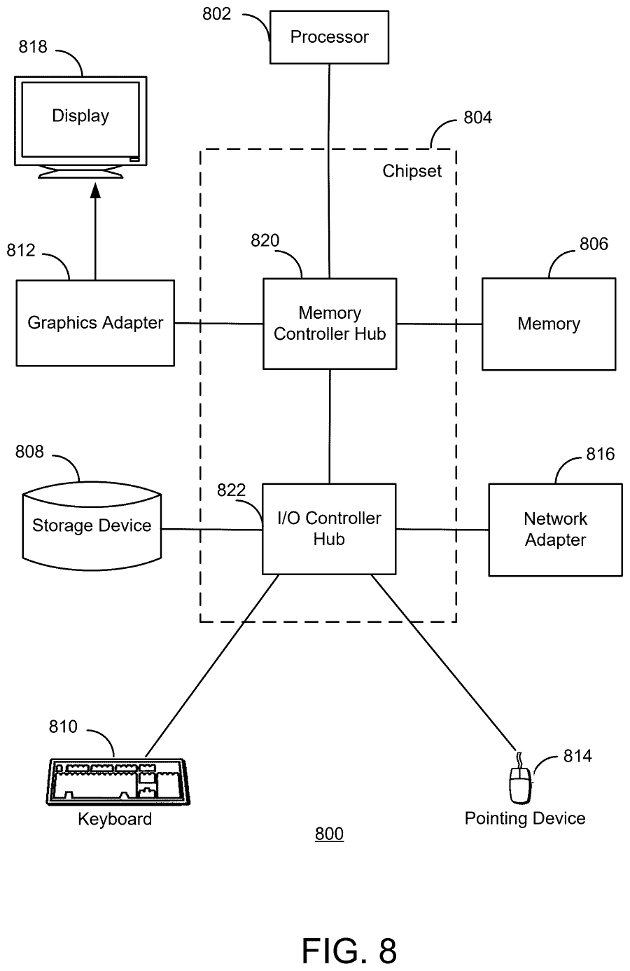

FIG. 8 depicts an example computing device 800 for implementing systems and methods described in reference to FIGS. 1-7. Examples of a computing device may include a personal computer, desktop computer laptop, server computer, a computing node within a cluster, message processors, hand-held devices, multi-processor systems, microprocessor-based or programmable consumer electronics, network PCs, minicomputers, mainframe computers, mobile telephones, PDAs, tablets, pagers, routers, switches, edge devices, IoT devices, and the like. In some embodiments, the computing device 800 may operate as an AI-powered unit. Thus, the computing device 800 may train and/or deploy machine learning models for automated rating.

In some embodiments, the computing device 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, an input interface 814, and a network adapter 816 are coupled to the I/O controller hub 822. Other embodiments of the computing device 800 have different architectures.

The storage device 808 is a non-transitory computer-readable storage medium such as a hard drive, compact disk read-only memory (CD-ROM), DVD, or a solid-state memory device. The Memory 806 holds instructions and data used by the processor 802. The input interface 814 is a touch-screen interface, a mouse, trackball, or other types of input interface, a keyboard, or some combination thereof, and is used to input data into the computing device 800. In some embodiments, the computing device 800 may be configured to receive input (e.g., commands) from the input interface 814 via gestures from the user. The graphics adapter 812 displays images and other information on the display 818. The network adapter 816 couples the computing device 800 to one or more computer networks.

The computing device 800 is adapted to execute computer program modules for providing the functionality described herein. As used herein, the term “module” refers to computer program logic used to provide the specified functionality. Thus, a module may be implemented in hardware, firmware, and/or software. In one embodiment, program modules are stored on the storage device 808, loaded into the memory 806, and executed by the processor 802.

The types of computing devices 800 may vary from the embodiments described herein. For example, the computing device 800 may lack some of the components described above, such as graphics adapters 812, input interface 814, and displays 818. In some embodiments, a computing device 800 may include a processor 802 for executing instructions stored on a memory 806.

The methods disclosed herein may be implemented in hardware or software, or a combination of both. In one embodiment, a non-transitory machine-readable storage medium, such as the one described above, is provided, the medium comprising a data storage material encoded with machine-readable data which, when using a machine programmed with instructions for using said data, is capable of displaying any of the datasets and execution and results of this disclosure. Such data may be used for a variety of purposes, such as patient monitoring, treatment considerations, and the like. Embodiments of the methods described above may be implemented in computer programs executing on programmable computers, comprising a processor, a data storage system (including volatile and non-volatile memory and/or storage elements), a graphics adapter, an input interface, a network adapter, at least one input device, and at least one output device. A display is coupled to the graphics adapter. Program code is applied to input data to perform the functions described above and generate output information. The output information is applied to one or more output devices, in a known fashion. The computer may be, for example, a personal computer, microcomputer, or workstation of conventional design.

Each program may be implemented in a high-level procedural or object-oriented programming language to communicate with a computer system. However, the programs may be implemented in assembly or machine language, if desired. In any case, the language may be a compiled or interpreted language. Each such computer program is preferably stored on a storage media or device (e.g., ROM or magnetic diskette) readable by a general or special-purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

The databases thereof may be provided in a variety of media to facilitate their use. “Media” refers to a manufacturer that contains the rating-related information of the present disclosure. The databases of the present disclosure may be recorded on computer-readable media, e.g., any medium that may be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skilled in the art may readily appreciate how any of the presently known computer readable mediums may be used to create a manufacture comprising a recording of the present database information. “Recorded” refers to a process for storing information on a computer-readable medium, using any such methods as known in the art. Any convenient data storage structure may be chosen, based on the means used to access the stored information. A variety of data processor programs and formats may be used for storage, e.g., word processing text files, database format, etc.

What is claimed is:

1. An AI-powered rating system, comprising:
a central artificial intelligence (AI) agent framework configured to orchestrate a rating process and automatically utilize available tools for data gathering and extraction;
a data processing pipeline configured to simultaneously handle multiple streams of information from diverse sources, including structured data and unstructured data;
a machine learning infrastructure comprising multiple specialized artificial intelligence models, each configured to evaluate a specific type of entity;
a generative AI integration layer configured to provide a natural language explanation of a rating result for the rating process and enable conversational interaction with the system, wherein the generative AI integration layer is further configured to transform the unstructured data into quantifiable risk signals that are integrated with a structured data processing stream; and
an output generation and reporting engine configured to deliver the rating result through one or more channels and formats.

2. The system of claim 1, further comprising:
a query processing and scenario analysis engine configured to intelligently route user queries and execute one or more what-if analyses.

3. The system of claim 1, wherein the data processing pipeline further comprises:
a classification framework configured to define AI rating sectors for each type of entity using standard industrial classification (SIC) codes and generative AI;
a data verification component configured to use alternative sources to validate and enhance the unstructured data; and
a quality assurance component configured to remove outlier records and standardize data formats.

4. The system of claim 1, wherein the machine learning infrastructure comprises:
a predictive model calibrated to determine credit risk through historical and real time inputs;
a simulation model calibrated to determine credit risk through stress-testing scenarios;
a real-time pricing model calibrated to determine dynamic asset prices;
a synthetic asset pricing model configured to generate synthetic data for an entity with certain missing data; and
one or more feature engineering components configured to determine an impact direction, remove a minimal impact feature, clip an extreme value, and detect sharp edges using an individual conditional expectation (ICE) plot.

5. The system of claim 1, wherein the machine learning infrastructure is configured to implement an indirect risk prediction methodology by:
predicting an option-adjusted spread (OAS) using collected data from the diverse sources; and
estimating a probability of default based on the predicted OAS rather than directly predicting default probability.

6. The system of claim 1, wherein the generative AI integration layer comprises:
a retrieval augmented generation (RAG) framework configured to search through documents and data to find relevant information;
a natural language processing component configured to generate the natural language explanation of the rating result in real-time;
a news distillation component configured to synthesize asset-related news for the specific type of entity; and
a conversational interface configured to enable users to query the system about the rating result or entity-related information.

7. The system of claim 2, wherein the query processing and scenario analysis engine is configured to:
categorize the user queries into simple what-if, complex what-if, non-what-if questions, and inappropriate questions;
formulate an execution plan for a complex scenario;
execute the plan using one or more of an internet search, a document analysis, a research report, or a modeling tool; and
generate a result with a citation for information sources used.

8. The system of claim 1, wherein the output generation and reporting engine is configured to deliver content through one or more of a web-based user interface, an application programming interface (API), a data feed and flat file, a notification via text and email, a mobile application, or an Excel or Google Sheets plugin.

9. The system of claim 1, further comprising: a data quality and validation engine configured to automatically check and clean incoming information before use in rating calculations, including identifying outdated information, missing values, duplicate data, and unrealistic numbers compared to historical patterns.

10. The system of claim 1, further comprising: a real-time monitoring and alert system configured to continuously monitor generated ratings and send flagged alerts through message transmission applications when assets are identified as having ratings below predefined thresholds.

11. The system of claim 10, wherein the real-time monitoring and alert system is configured to:
employ a machine learning algorithm to establish dynamic thresholds based on historical patterns and market conditions;
categorize alerts by severity level and route them to appropriate stakeholders;
support multiple notification channels including email, SMS, mobile push notifications, and API-based integrations; and
activate message transmission applications to display alerts on remote devices when the remote devices come online.

12. The system of claim 1, wherein the machine learning infrastructure is configured to:
determine training window length and decaying weight approaches to maximize performance;
use cross-validation to determine hyperparameter settings; and
re-fit final models on full samples; and
fit models daily to maintain current relevance.

13. The system of claim 1, wherein the multiple specialized artificial intelligence models are configured to cover specific asset classes including corporates, financial institutions, insurance companies, asset-backed securities, and governments, with each model optimized for risk characteristics of its respective asset class.

14. The system of claim 1, further comprising a model stacking framework configured to combine predictions from structured data models with signals derived from unstructured data and alternative datasets.

15. The system of claim 1, wherein the data processing pipeline is configured to:
perform data quality checks and data cleaning operations; and
integrate all data streams into a unified analytical framework.

16. A computer-implemented method for generating AI-powered asset ratings, the method comprising:
receiving, by a central AI agent framework, a request for credit assessment of an entity;
automatically gathering, by the central AI agent framework, data from multiple sources including structured data and unstructured data;
processing the gathered data through a data processing pipeline configured to handle diverse data formats, wherein processing the gathered data comprises transforming the unstructured data into quantifiable risk signals that are integrated with a structured data processing stream;
executing one or more specialized machine learning models on the processed data to generate a risk assessment;
converting model outputs into standardized probability scores through data transformation; and
generating a rating by mapping the probability scores to traditional rating categories through historical calibration.

17. The method of claim 16, further comprising:
implementing an indirect risk prediction methodology by predicting an option-adjusted spread (OAS) using the processed data; and
estimating a probability of default based on the predicted OAS.

18. The method of claim 16, further comprising:
receiving a user query regarding the generated rating;
categorizing the query as a simple what-if question, complex what-if question, non-what-if question, or inappropriate question;
if the user query is the complex what-if question, formulating an execution plan;
executing the plan using one or more of an internet search, a document analysis, and a research report, or a modeling tool; and
presenting a result with a citation for information sources used.

19. The method of claim 16, further comprising:
continuously monitoring the generated rating against a predefined threshold;
detecting that the generated rating falls below the predefined threshold;
generating a flagged alert categorized by severity level; and
transmitting the alert through one or more notification channels to an appropriate stakeholder.

20. The method of claim 16, further comprising:
generating, using a generative AI integration layer, a natural language explanation of the generated rating in real-time; and
providing the explanation through one or more output channels to a user submitting the request.
